(19) United States
(12) Patent Application Publication
(10) Pub. No.: US 2023/0291270 A1
(43) Pub. Date: Sep. 14, 2023

(54) COOLING DEVICE FOR ELECTRIC MOTOR

(71) Applicant: TOYOTA JIDOSHA KABUSHIKI KAISHA, Toyota-shi (JP)

(72) Inventor: Kenta TABUCHI, Toyota-shi (JP)

(73) Assignee: TOYOTA JIDOSHA KABUSHIKI KAISHA, Toyota-shi (JP)

(21) Appl. No.: 18/119,016

(22) Filed: Mar. 8, 2023

(30) Foreign Application Priority Data
Mar. 11, 2022 (JP) 2022-038436

(51) Int. Cl. H02K 5/20; H02K 9/19; H02K 7/00

(52) U.S. Cl. CPC H02K 5/20; H02K 9/19; H02K 7/003

(57) ABSTRACT

A cooling device for an electric motor that includes (i) a stator including a stator core and a stator coil, and (ii) a rotor. The electric motor is located in a position adjacent to a resolver in a direction of the rotation axis. The resolver includes a resolver stator, a resolver rotor and a resolver coil. The cooling device includes (a) a refrigerant supply mechanism and (b) an oil guide which is provided in an annular-shaped cover covering the resolver coil, for supplying a refrigerant supplied from the refrigerant supply mechanism onto a lower portion of a coil end of the stator coil. The oil guide includes a guide wall which extends in the direction of the rotation axis and in a circumferential direction of the annular-shaped cover. At least a portion of the guide wall overlaps with the coil end as seen from a radial direction.

This application claims priority from Japanese Patent Application No. 2022-038436 filed on Mar. 11, 2022, the disclosure of which is herein incorporated by reference in its entirety.

### FIELD OF THE INVENTION

The present invention relates to improvement of cooling performance of a cooling device for an electric motor.

### BACKGROUND OF THE INVENTION

There are proposed various kinds of cooling devices for cooling electric motor. For example, JP-2018-68086A discloses a motor casing for storing an electric motor, wherein the motor casing is provided with an inclined wall which extends toward a permanent magnet or periphery of the permanent magnet so as to guide a refrigerant scooped up by rotation of a rotor, toward the permanent magnet or periphery of the permanent magnet. The inclined wall extends to a space defined between a coil end and a rotor shaft.

### SUMMARY OF THE INVENTION

By the way, it is desired to supply the refrigerant to a lower portion of the coil end protruding from a stator core of the electric motor, from viewpoint of improving the cooling performance for cooling the electric motor. It might be possible to supply the refrigerant through the inclined wall as disclosed in the above-identified Japanese Patent Application Publication. However, there is proposed an arrangement in which a resolver is provided in the space defined between the coil end and the rotor shaft, so as to detect a rotational speed of the electric motor. In such a proposed arrangement, it is difficult to dispose the inclined wall in the above-described space. Further, where the electric motor is small in size, a space defined between the coil end and the resolver is made small, it becomes more difficult to provide a mechanism for guiding the refrigerant to the lower portion of the coil end.

The present invention was made in view of the background art described above. It is therefore an object of the present invention to provide a cooling device for an electric motor, wherein the cooling device is capable of providing refrigerant to a lower portion of a coil end even where the electric motor is small in size.

The object indicated above is achieved according to the following aspects of the present invention.

According to a first aspect of the invention, there is provided a cooling device for an electric motor that includes (i) a tubular stator including a tubular stator core and a stator coil passing through the stator core in a direction of a rotation axis of the electric motor, (ii) a tubular rotor disposed on an inner peripheral side of the stator and (iii) a shaft fixed in an inner circumferential surface of the rotor, such that the electric motor is located in a position adjacent to a resolver in the direction of the rotation axis, and such that the resolver includes a resolver stator fixed to a non-rotary member, a resolver rotor and a resolver coil that is wound on the resolver stator. The cooling device includes: (a) a refrigerant supply mechanism configured to supply a refrigerant to the electric motor; and (b) an oil guide which is provided in an annular-shaped cover covering the resolver coil, and which is configured to supply the refrigerant supplied from the refrigerant supply mechanism onto a portion of a coil end that is provided by a protruding portion of the stator coil protruding from the stator core, wherein the portion of the coil end is located on a lower side of the rotation axis in a vertical direction. The oil guide includes a guide wall which extends in the direction of the rotation axis, and which extends in a circumferential direction of the annular-shaped cover. At least a portion of the guide wall overlaps with the coil end as seen from a radial direction orthogonal to the rotation axis. It is noted the above-described “lower side of the rotation axis in a vertical direction” may be defined also as “one of opposite sides of the rotation axis that are opposite to each other in a radial direction orthogonal to the rotation axis, wherein the one of the opposite sides is more distant from the refrigerant supply mechanism than the other of the opposite sides of the rotation axis in the radial direction”.

According to a second aspect of the invention, in the cooling device according to the first aspect of the invention, the oil guide further includes an arc wall having an arc shape and extending in the circumferential direction of the annular-shaped cover, and a protruding wall extending in the radial direction from an end portion of the arc wall which is located on the lower side of the rotation axis in the vertical direction, wherein the guide wall is connected to an outer end of the protruding wall in the radial direction.

According to a third aspect of the invention, in the cooling device according to the second aspect of the invention, the oil guide includes, in addition to the arc wall as a first arc wall, a second arc wall that is located on an outer peripheral side of the first arc wall so as to cover the outer peripheral side of the first arc wall, wherein the second arc wall is provided with a cutout that is located on an upper side of the rotation axis in the vertical direction so as to guide an oil supplied from the refrigerant supply mechanism toward an inner peripheral side of the second arc wall.

According to a fourth aspect of the invention, in the cooling device according to the first aspect of the invention, the guide wall is inclined downwardly in the vertical direction, as the guide wall extends in the direction of the rotation axis toward the electric motor.

According to a fifth aspect of the invention, in the cooling device according to the first aspect of the invention, the refrigerant supply mechanism is configured to supply the refrigerant released from the refrigerant supply mechanism, to the oil guide through a through-hole that extends through the resolver stator in the direction of the rotation axis.

According to a sixth aspect of the invention, in the cooling device according to the first aspect of the invention, the oil guide is made of a resin material, wherein the oil guide is formed integrally with the annular-shaped cover.

According to a seventh aspect of the invention, in the cooling device according to the first aspect of the invention, the refrigerant supply mechanism is a coolant pipe which is disposed on an upper side of the electric motor in the vertical direction and which is provided with a supply hole through which the refrigerant is to be released.

In the cooling device according to the first aspect of the invention, the oil guide provided in the annular-shaped cover includes the guide wall which extends in the direction of the rotation axis and which extends in the circumferential direction of the annular-shaped cover, and at least a portion of the guide wall overlaps with the coil end as seen from the radial direction. Thus, when the refrigerant released from the refrigerant supply mechanism is moved along the annular-shaped cover and then is supplied to the oil guide, the oil is moved along the guide wall in the direction of the rotation axis and drops from a distal end of the guide wall, so that the oil having dropped from the distal end of the guide wall is supplied to the above-described portion (hereinafter referred to as “lower portion”) of the coil end which is located on the lower side of the rotation axis. Therefore, the oil can be appropriately supplied to the lower portion of the coil end. Further, since the oil guide is provided in the annular-shaped cover covering the resolver coil, the oil guide can be provided even where the electric motor is made compact in size.

In the cooling device according to the second aspect of the invention, when the oil supplied from the refrigerant supply mechanism reaches the annular-shaped cover, the oil is moved downwardly along the arc wall having the arc shape. Further, since the protruding wall is provided to extend in the radial direction from the end portion of the arc wall which is located on the lower side of the rotation axis, the oil moved downwardly along the arc wall collides with the protruding wall, whereby a direction of flow of the oil is changed to the radial direction in which the protruding wall extends. In this instance, since the guide wall is connected to the outer end of the protruding wall, the oil moved in the radial direction is moved along the guide wall in the direction of the rotation axis, and then drops from a distal end of the guide wall toward the lower portion of the coil end. Thus, the oil supplied from the refrigerant supply mechanism is collected onto the guide wall via the arc wall and protruding wall, so that the oil is efficiently supplied to the lower portion of the coil end.

In the cooling device according to the third aspect of the invention, the second arc wall is provided on the outer peripheral side of the first arc wall so as to cover the outer peripheral side of the first arc wall. Therefore, even if the oil is deviated from the first arc wall, the deviated oil is returned by the second arc wall onto the first arc wall, so that it is possible to reduce flow of the oil out from the first arc wall. Further, since the second arc wall is provided with the cutout that is located on the upper side of the rotation axis, the oil supplied from the refrigerant supply mechanism is guided through the cutout toward the inner peripheral side of the second arc wall.

In the cooling device according to the fourth aspect of the invention, the guide wall is inclined downwardly as the guide wall extends in the direction of the rotation axis toward the electric motor, so that the oil having arrived the guide wall is moved in the direction of the rotation axis owing to inclination of the guide wall. Consequently, the oil having arrived the guide wall is moved along the guide wall so as to be efficiently supplied to the lower portion of the coil end.

In the cooling device according to the fifth aspect of the invention, the oil supplied from the refrigerant supply mechanism passes through the through-hole provided through the resolver stator so as to be supplied toward the annular-shaped cover. Therefore, even where it is difficult to supply the oil toward the annular-shaped cover through a clearance defined between the resolver and the coil end, the oil supplied from the refrigerant supply mechanism can be supplied toward the annular-shaped cover.

In the cooling device according to the sixth aspect of the invention, the oil guide is formed integrally with the annular-shaped cover, so that it is possible to avoid a new part or component from being added to form the oil guide.

In the cooling device according to the seventh aspect of the invention, the refrigerant can be supplied toward the electric motor from the supply hole of the coolant pipe that is disposed on the upper side of the electric motor in the vertical direction.

### BRIEF DESCRIPTION OF THE DRAWINGS

FIG. 1 is a cross sectional view schematically showing an electric motor to which the present invention is applied;

FIG. 2 is a view of a resolver as seen from a direction of arrow A shown in FIG. 1; and

FIG. 3 is a view showing directions in which first and second moulds are to be withdrawn, wherein the first and second moulds are to be used for producing a first cover.

### DETAILED DESCRIPTION OF PREFERRED EMBODIMENT

There will be described embodiment of the present invention in details with reference to drawings. It is noted that figures of the drawings are simplified or deformed as needed, and each portion is not necessarily precisely depicted in terms of dimension ratio, shape, etc., for easier understanding of the embodiment.

### EMBODIMENT

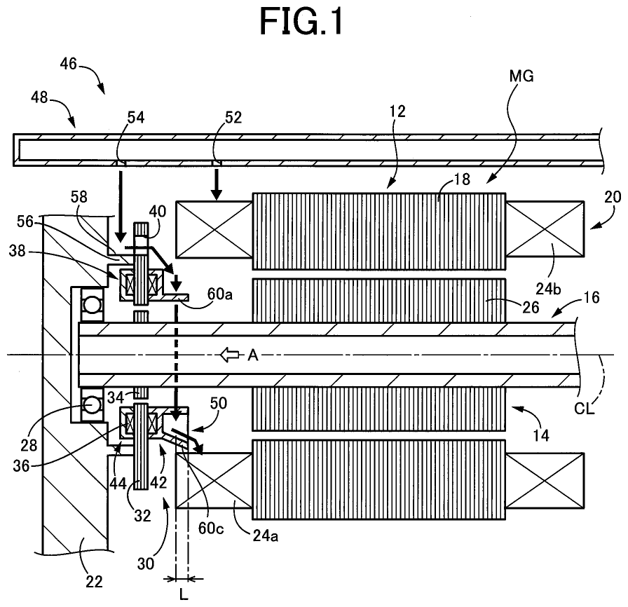

FIG. 1 is a cross sectional view schematically showing an electric motor MG to which the present invention is applied. The electric motor MG is to be used, for example, as a drive power source provided in a vehicle. The electric motor MG, whose center corresponds to a rotation axis CL, includes a cylindrical tubular stator 12 as a non-rotary member, a cylindrical tubular rotor 14 disposed on an inner peripheral side of the stator 12, and a rotor shaft 16 fixed in an inner circumferential surface of the rotor 14. It is noted that the rotor shaft 16 corresponds to “shaft” recited in the appended claims.

The stator 12 includes a stator core 18 formed to have a cylindrical tubular shape and a plurality of stator coils 20 extending through the stator core 18 in a direction of the rotation axis CL.

The stator core 18 is constituted by a plurality of insulated electromagnetic steel plates that are laminated in the direction of the rotation axis CL. The stator core 18 is unrotatably fixed to a motor casing 22 through screw bolts (not shown). The stator core 18 has a plurality of slots (not shown) that are spaces extending outwardly from an inner circumferential surface of the stator core 18 in a radial direction of the stator core 18. The slots are arranged at equal angular intervals in a circumferential direction of the stator core 18, and extend through the stator core 18 in the direction of the rotation axis CL. The stator coils 20 are provided to pass through each of the slots in the direction of the rotation axis CL. A pair of coil ends 24a, 24b are constituted by protruding portions of the stator coils 20, which protrude from the stator core 18 in the direction of the rotation axis CL. Each of the coil ends 24a, 24b has an annular shape and extends in a circumferential direction of the stator core 18.

The rotor 14 includes a rotor core 26 that is formed to have a cylindrical tubular shape. The rotor core 26 is constituted by a plurality of insulated electromagnetic steel plates that are laminated in the direction of the rotation axis CL. The rotor shaft 16 is integrally fixed to an inner circumferential surface of the rotor core 26. The rotor shaft 16 is formed to have a cylindrical tubular shape, and is rotatably supported by, for example, bearings 28 provided in respective end portions of the rotor shaft 16 that are opposite to each other in the direction of the rotation axis CL, such that the rotor shaft 16 is rotatable about the rotation axis CL.

A resolver 30 is provided in a position that is adjacent to the electric motor MG in the direction of the rotation axis CL. The resolver 30 is disposed between the motor casing 22 and the electric motor MG in the direction of the rotation axis CL, and serves as a rotational speed sensor configured to detect a rotational speed of the electric motor MG.

The resolver 30 includes a disk-shaped resolver stator 32, a disk-shaped resolver rotor 34 disposed on an inner peripheral side of the resolver stator 32, and resolver coils 36 wound on the resolver stator 32.

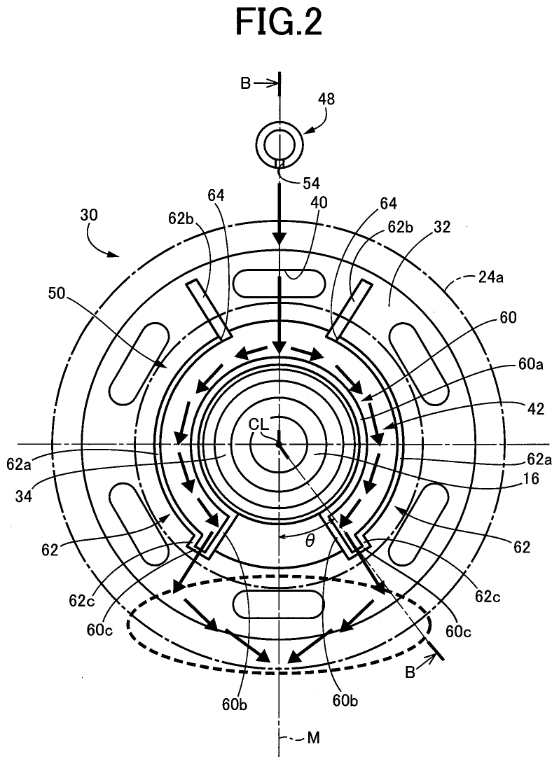

The resolver stator 32 is fastened, through screw bolts (not shown), to a resolver support portion 56 that protrudes from the motor casing 22 in the direction of the rotation axis CL, so that the resolver stator 32 is fixed to the motor casing 22 as the non-rotary member. Further, the resolver stator 32 is provided with a plurality of elongated holes 40 each extending through the resolver stator 32 in the direction of the rotation axis CL. The plurality of elongated holes 40 are arranged at equal angular intervals in a circumferential direction of the resolver stator 32, and are elongated generally in the circumferential direction of the resolver stator 32 as seen from the direction of the rotation axis CL (see FIG. 2). It is noted that each of the elongated holes 40 corresponds to “through-hole” recited in the appended claims.

With the resolver rotor 34 being fixed at its inner circumferential surface to an outer circumferential surface of the rotor shaft 16, the resolver rotor 34 is rotatable integrally with the rotor shaft 16. The resolver coils 36 are inserted through through-holes (not shown) that are provided in the resolver stator 32, so as to be wound on the resolver stator 32.

The resolver stator 32 is provided with a cover 38 for protecting the resolver coils 36 wound on the resolver stator 32. The cover 38 is formed to have an annular shape so as to cover the resolver coils 36 wound on the resolver stator 32 substantially in the entire circumferential direction. The cover 38 is made of a resin material.

The cover 38 includes a first cover 42 having an annular shape and covering the resolver coils 36 protruding from the resolver stator 32 toward the electric motor MG in the direction of the rotation axis CL, and a second cover 44 having an annular shape and covering the resolver coils 36 protruding from the resolver stator 32 toward the bearing 28 in the direction of the rotation axis CL. The first and second covers 42, 44 are both located on an inner peripheral side of the coil end 24a of the electric motor MG. It is noted that the first cover 42 corresponds to “annular-shaped cover” recited in the appended claims.

There will be described a cooling device 46 for cooling the coil end 24a of the electric motor MG. The cooling device 46 includes a coolant pipe 48 that is disposed on an upper side of the electric motor MG in a vertical direction in an assembled state and an oil guide 50 configured to guide an oil as a refrigerant released from the coolant pipe 48, to the coil end 24a. In the following description, the term “assembled state” means a state in which the cooling device 46 is fixed relative to the electric motor MG on a horizontal plane. Therefore, in FIG. 1 showing the assembled state, an upward direction in the drawing sheet corresponds to an upward direction of an assembly of the cooling device 46 and the electric motor MG.

The coolant pipe 48 extends in parallel to the rotation axis CL of the electric motor MG, namely, a longitudinal direction of the coolant pipe 48 corresponds to the direction of the rotation axis CL. The oil, which is scooped up by an oil pump (not shown), is supplied to the coolant pipe 48. The coolant pipe 48 is provided with first and second supply holes 52, 52 located in respective positions that are opposed to the electric motor MG in a circumferential direction of the coolant pipe 48. Therefore, the oil supplied to the coolant pipe 48 is released through the first and second supply holes 52, 54 that are located above the electric motor MG so as to be supplied to the electric motor MG. It is noted that each of the first and second supply holes 52, 54 corresponds to “supply hole” recited in the appended claims, and the coolant pipe 48 provided with the first and second supply holes 52, 54 corresponds to “refrigerant supply mechanism” recited in the appended claims.

The first supply hole 52 is located in a position that overlaps with the coil end 24a in the longitudinal direction of the coolant pipe 48 as seen from the radial direction orthogonal to the rotation axis CL. Therefore, the oil released from the first supply hole 52 is supplied to an upper portion of the coil end 24a in the vertical direction, as indicated by arrow in FIG. 1, so as to cool mainly the upper portion of the coil end 24a. Further, the oil having cooled the upper portion of the coil end 24a is moved downwardly along the coil end 24a. In this instance, a temperature of the oil has been increased when the oil has bee moved down to a lower portion of the coil end 24a, so that an amount of heat dissipation by the oil is reduced thereby making it difficult to appropriately cool the lower portion of the coil end 24a. Consequently, a temperature of the lower portion of the coil end 24a is likely to be higher than a temperature of the upper portion of the coil end 24a.

In the present embodiment, the cooling device 46 is configured to supply the oil released from the second supply hole 54, to the lower portion of the coil end 24a through the oil guide 50. The second supply hole 54 is located in a position that overlaps with the resolver support portion 56 holding the resolver stator 32, in the longitudinal direction of the coolant pipe 48 as seen from the radial direction orthogonal to the rotation axis CL. The resolver support portion 56 is a part of the motor casing 22, which protrudes from a wall surface of the motor casing 22 toward the resolver 30.

The oil released from the second supply hole 54 is supplied to a resolver seating surface 58 of the resolver support portion 56, as indicated by arrow in FIG. 1. The oil supplied to the resolver seating surface 58 is moved through one of the elongated holes 40 provided through the resolver stator 32, toward the first cover 42. Each of the elongated holes 40 is formed to have an elongated shape to adjust an assembled position of the resolver stator 32. The elongated holes 40 are arranged in the circumferential direction of the resolver stator 32. The resolver seating surface 58 is provided in substantially the same height position as an uppermost one of the elongated holes 40 which is located higher than the other elongated holes 40 in the vertical direction in the assembled state. Thus, the oil supplied to the resolver seating surface 58 passes through the uppermost elongated hole 40 so as to be moved to the first cover 42. Thus, since the oil is moved from one of opposite sides of the resolver stator 32 to the other side of the resolver stator 32 through one of the elongated holes 40, it is necessary to form another hole through which the oil is to pass. It is noted that the resolver stator 32 is fastened to the motor casing 22 through the screw bolts by using the other elongated holes 40 other than the uppermost elongated hole 40 through which the oil is to pass.

As described above, the uppermost elongated hole 40, which is located higher than the other elongated holes 40 in the vertical direction in the assembled state, is used as a supply hole through which the oil is to be supplied. That is, the oil released from the second supply hole 54 of the coolant pipe 48 is moved through the uppermost elongated hole 40 from the resolver seating surface 58 of the resolver support portion 56, i.e., from one of opposite sides of the resolver stator 32, to the other side of the resolver stator 32 on which the first cover 42 and the oil guide 50 are located. Thus, although a space between the rotor shaft 16 and the coil end 24a is closed by the resolver 30, the oil can be supplied through the uppermost elongated hole 40 onto a side of the first cover 42, i.e., on the inner peripheral side of the coil end 24a.

The oil having passed through the uppermost elongated hole 40 is moved onto the side of the first cover 42 and is then supplied to the lower portion of the coil end 24a through the oil guide 50 that is provided in the first cover 42. The oil guide 50 is provided to supply the oil released from the second supply hole 54 of the coolant pipe 48, to the lower portion of the coil end 24a, i.e., a portion of the coil end 24a that is located on a lower side of the rotation axis CL in the vertical direction. The oil guide 50 is made of a resin material, and is formed integrally with the first cover 42. The oil guide 50 extends from the first cover 42 toward the electric motor MG in the direction of the rotation axis CL. Further, the oil guide 50 extends such that at lease a part of the oil guide 50 is located in a position that overlaps with the coil end 24a in the direction of the rotation axis CL, as seen from the radial direction orthogonal to the rotation axis CL.

FIG. 2 is a view of the resolver 30 in the assembled state, as seen from the direction of arrow A shown in FIG. 1. In FIG. 2 showing the assembled state, an upward direction in the drawing sheet corresponds the upward direction in the assembly of the cooling device 46 and the electric motor MG. Further, in FIG. 2, arrows indicate of flow of the oil released from the second supply hole 54 of the coolant pipe 48. It is noted that the coil end 24a is indicated by one-dot chain lines in FIG. 2, and that the cross sectional view of FIG. 1 is taken along line B-B shown in FIG. 2.

As shown in FIG. 2, the plurality of elongated holes 40 provided in the resolver stator 32 consist of six elongated holes 40 that are arranged at equal angular intervals in the circumferential direction. The oil released from the second supply hole 54 is supplied to the oil guide 50, passing through the uppermost elongated holes 40, i.e., one of the six elongated holes 40 which is located higher than the other elongated holes 40 in the vertical direction.

The first cover 42 is formed to have an annular shape and extends in the circumferential direction of the resolver stator 32, so as to cover the resolver coils 36. The oil guide 50 extends in the direction of the rotation axis CL from a wall surface of the first cover 42 that is perpendicular to the rotation axis CL. The oil guide 50 includes an inner-peripheral guide portion 60 which is formed to extend in a circumferential direction of the first cover 42 and an outer-peripheral guide portion 62 which is located on an outer peripheral side of the inner-peripheral guide portion 60 and which is formed to cover the inner-peripheral guide portion 60.

The inner-peripheral guide portion 60 includes an inner-peripheral arc wall 60a that is formed to have an arc shape and extends along an inner peripheral end of the first cover 42, a pair of inner-peripheral protruding walls 60b radially extending from respective end portions of the inner-peripheral arc wall 60a that are opposite to each other in the circumferential direction, and a pair of guide walls 60c extending along the circumferential direction of the first cover 42, as seen from the direction of the rotation axis CL. Since the inner-peripheral guide portion 60 is formed symmetrically with respect to a straight line M passing through a center (axis) of the coolant pipe 48 and the rotation axis CL, the same reference sign “60b” is given to the pair of inner-peripheral protruding walls, and the same reference sign “60c” is given to the pair of guide walls. It is noted that the inner-peripheral arc wall 60a corresponds to “arc wall” recited in the appended claims and that each of the inner-peripheral protruding walls 60b corresponds to “protruding wall” recited in the appended claims.

The inner-peripheral arc wall 60a is formed to have the arc shape and extends along the inner peripheral end of the first cover 42, such that opposite ends of the arc are located on the lower side of the rotation axis CL. Thus, on the upper side of the rotation axis CL, the inner-peripheral arc wall 60a covers an entirety of the inner peripheral end of the first cover 42. Further, the inner-peripheral arc wall 60a extends also in the direction of the rotation axis CL, such that a part of the inner-peripheral arc wall 60a overlaps with the coil end 24a in the direction of the rotation axis CL, as seen from the radial direction orthogonal to the rotation axis CL (see FIG. 1).

Each of the inner-peripheral protruding walls 60b extends outwardly in the radial direction from a corresponding one of the opposite ends of the inner-peripheral arc wall 60a, which are located on the lower side of the rotation axis CL in the vertical direction, as seen from the direction of the rotation axis CL. Each of the inner-peripheral protruding walls 60b extends in the radial direction to a position located outside an outer peripheral end of the first cover 42 in the radial direction. Further, a radially outer end of each of the inner-peripheral protruding walls 60b is inclined relative to the direction of the rotation axis CL in the assembled state, as seen from the circumferential direction of the first cover 42, such that the radially outer end of each of the inner-peripheral protruding walls 60b is inclined outwardly in the radial direction as the radially outer end extends toward the electric motor MG. Further, each of the each of the inner-peripheral protruding walls 60b extends also in the direction of the rotation axis CL, such that a part of each of the inner-peripheral protruding walls 60b overlaps with the coil end 24a in the direction of the rotation axis CL, as seen from the radial direction orthogonal to the rotation axis CL.

Each of the guide walls 60c extends in the direction of the rotation axis CL, along the radially outer end of a corresponding one of the inner-peripheral protruding walls 60b. Like the radially outer end of each of the inner-peripheral protruding walls 60b, each of the guide walls 60c is inclined relative to the direction of the rotation axis CL in the assembled state, such that each of the guide walls 60c is inclined outwardly in the radial direction as each of the guide walls 60c extends toward the electric motor MG in the direction of the rotation axis CL. Since the guide walls 60c are located on the lower side of the rotation axis CL in the assembled state, each of the guide walls 60c is inclined downwardly in the vertical direction, practically, as each of the guide walls 60c extends toward the electric motor MG in the direction of the rotation axis CL. Each of the guide walls 60c is connected to the radially outer end of a corresponding one of the inner-peripheral protruding walls 60b, and extends along the radially outer end of the corresponding inner-peripheral protruding wall 60b in the direction of the rotation axis CL. Further, each of the each of the guide walls 60c extends in the direction of the rotation axis CL, such that a part of each of the guide walls 60c overlaps with the coil end 24a in the direction of the rotation axis CL, as seen from the radial direction orthogonal to the rotation axis CL (see FIG. 1).

The outer-peripheral guide portion 62 includes an outer-peripheral arc wall 62a that is located on an outer peripheral side of the inner-peripheral arc wall 60a, a pair of oil capture walls 62b extending outwardly in the radial direction from end portions of respective two divided walls into which the outer-peripheral arc wall 62a is divided by a cutout 64 that is described below, and a pair of outer-peripheral protruding walls 62c extending outwardly in the radial direction from end portions of the outer-peripheral arc wall 62a that are located on the lower side of the rotation axis CL in the assembled state. Since the outer-peripheral guide portion 62 is formed symmetrically with respect to the above-described straight line M, the same reference sign “62b” is given to the pair of oil capture walls, and the same reference sign “62c” is given to the pair of outer-peripheral protruding walls. It is noted that the outer-peripheral arc wall 62a corresponds to “second arc wall” recited in the appended claims.

The outer-peripheral arc wall 62a is located on the outer peripheral side of the inner-peripheral arc wall 60a so as to cover the outer peripheral side of the inner-peripheral arc wall 60a. The outer-peripheral arc wall 62a is formed to have an arc shape and extends along the outer peripheral end of the first cover 42. The above-described cutout 64 is provided in a portion of the outer-peripheral arc wall 62a which is located on the upper side of the rotation axis CL in the vertical direction in the assembled state, so as to divide the outer-peripheral arc wall 62a into the above-described two divided walls. With the cutout 64 being provided, a space is provided in the portion of the outer-peripheral arc wall 62a in the circumferential direction. The space is located in a position that overlaps with the above-described uppermost elongated hole 40 (i.e., one of the elongated holes 40 which is located higher than the other elongated holes 40 in the vertical direction in the assembled state) in the radial direction. That is, the above-described space is located below the uppermost elongated hole 40 in the assembled state. Thus, the oil having passed through the uppermost elongated hole 40 can pass through the space so as to be moved toward the inner-peripheral guide portion 60. Thus, the cutout 64 is provided to guide the oil supplied from the coolant pipe 48, onto the inner peripheral side of the outer-peripheral arc wall 62a.

The pair of oil capture walls 62b extend outwardly in the radial direction from the end portions of the respective two divided walls into which the outer-peripheral arc wall 62a is divided by the cutout 64. Each of the oil capture walls 62b extends outwardly in the radial direction to a position of the uppermost elongated hole 40 which is located outside an inner periphery of the coil end 24a in the radial direction, as seen from the direction of the rotation axis CL. Each of the oil capture walls 62b extends also in the direction of the rotation axis CL to a position close to the coil end 24a in the direction of the rotation axis CL.

The pair of outer-peripheral protruding walls 62c extend outwardly in the radial direction from the end portions of the outer-peripheral arc wall 62a that are located on the lower side of the rotation axis CL. A radially outer end of each of the outer-peripheral protruding walls 62c is inclined relative to the direction of the rotation axis CL in the assembled state, as seen from the circumferential direction of the first cover 42, such that the radially outer end of each of the outer-peripheral protruding walls 62c is inclined outwardly in the radial direction as the radially outer end extends toward the electric motor MG. Each of the guide walls 60c is connected to the radially outer end of a corresponding one of the outer-peripheral protruding walls 62c, and extends along the radially outer end of the corresponding outer-peripheral protruding wall 62c in the direction of the rotation axis CL. Therefore, each of the guide walls 60c is connected at its widthwise opposite ends to the radially outer end of the corresponding inner-peripheral protruding wall 60b and the radially outer end of the corresponding outer-peripheral protruding wall 62c. Thus, as shown in FIG. 2, a generally U-shaped oil passage is defined, with both sides of each of the guide walls 60c being sandwiched between the corresponding inner-peripheral protruding wall 60b and the corresponding outer-peripheral protruding wall 62c. The oil passage, which is defined by also the guide walls 60c, extends also in the direction of the rotation axis CL, such that a part of the oil passage overlaps with the coil end 24a in the direction of the rotation axis CL, as seen from the radial direction orthogonal to the rotation axis CL.

Next, the flow of the oil supplied from the coolant pipe 48 will be described. In FIG. 2, the arrows indicate of the flow of the oil released from the second supply hole 54 of the coolant pipe 48. The oil released from the second supply hole 54 reaches down to the resolver seating surface 58 (see FIG. 1), and passes through the uppermost elongated hole 40, so as to be supplied to the above-described other side of the resolver stator 32 on which the first cover 42 is located.

The oil having reached the other side of the resolver stator 32 on which the first cover 42 is located passes through the space defined by the cutout 64 of the outer-peripheral arc wall 62a so as to be supplied onto the inner-peripheral arc wall 60a of the inner-peripheral guide portion 60. In this instance, the oil having passed through the uppermost elongated hole 40 is reliably captured by the oil capture walls 62b provided on opposite sides of the uppermost elongated hole 40 that are opposite to each other in the circumferential direction, and is guided onto the inner-peripheral arc wall 60a.

The oil having reached the inner-peripheral arc wall 60a is moved downwardly along a circumferential wall of the inner-peripheral arc wall 60a. The oil having been moved downwardly along the circumferential wall collides with the inner-peripheral protruding walls 60b whereby a direction of the flow of the oil is changed to an outwardly radial direction. Then, the oil flowing in the outwardly radial direction collides with the guide walls 60c, whereby the direction of the oil flow is changed to the direction of the rotation axis CL. Thus, the oil having collided with the guide walls 60c is moved along the guide walls 60c in the direction of the rotation axis CL, and then drops down from distal ends of the guide walls 60c toward the coil end 24a. In this instance, since each of the guide walls 60c is inclined relative to the direction of the rotation axis CL downwardly in the vertical direction as each of the guide walls 60c extends toward the electric motor MG in the direction of the rotation axis CL, the oil having collided with the guide walls 60c is efficiently moved along the inclined guide walls 60c in the direction of the rotation axis CL so as to be supplied to the lower portion of the coil end 24a. Further, since a part of each of the guide walls 60c overlaps with the coil end 24a in the direction of the rotation axis CL, as seen from the radial direction orthogonal to the rotation axis CL, the oil can be supplied to a center or vicinity of the center of the coil end 24a in the direction of the rotation axis CL. An amount L (see FIG. 1) of overlap of each of the guide walls 60c with the coil end 24a is obtained by experimentation or determined by an appropriate design theory, such that the amount L is set to a suitable value that causes the oil having dropped from the distal end of each of the guide walls 60c to be supplied to the center or vicinity of the center of the coil end 24a in the direction of the rotation axis CL.

Further, each of the guide walls 60c is located in a position that is offset by a predetermined angle θ (see FIG. 1) in the circumferential direction of the first cover 42 from an angular position corresponding to a lowermost point of the coil end 24a in the vertical direction. Therefore, the oil flowing out from the distal end of each of the guide walls 60c is supplied to a position located on an upper side of the lowermost point of the coil end 24a, and is then moved along the coil end 24a to a lower end of the coil end 24a, so that a part of the coil end 24a surrounded by broken line in FIG. 2 is cooled by the oil. The predetermined angle θ is obtained by experimentation or determined by an appropriate design theory, such that the angle θ is set to a suitable angle value that causes the oil to be efficiently supplied to a part of the coil end 24a in which a temperature is more likely to be increased.

Consequently, the cooled oil is supplied directly to the lower portion of the coil end 24a in which the temperature is more likely to be increased, so that a temperature difference between the coil end 24a and the oil is made large whereby a heat transfer coefficient is increased. Further, since it is possible to increase an area of the coil end 24a with which the oil can be brought into contact, the temperature of the lower portion of the coil end 24a can be efficiently reduced. In connection with this, it becomes possible to increase an electric current applied to the electric motor MG, thereby making it possible to reduce a size of the electric motor MG. Therefore, it is possible to reduce an amount of material used to manufacture the electric motor MG. In addition, restrictions on a rated output of the electric motor MG dependent on the temperature increase of the coil end 24a are relaxed, enabling further improvements in acceleration performance. Moreover, the reduction of the temperature of the coil end 24a leads to reduction of copper loss, thereby resulting in improvement of fuel efficiency.

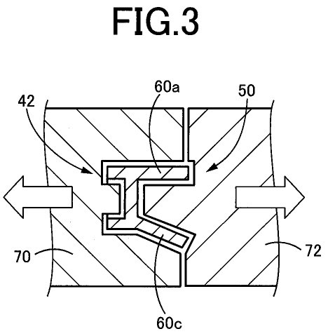

FIG. 3 is a view showing directions in which first and second moulds 70, 72 are to be withdrawn, wherein the first and second moulds 70, 72 are to be used for producing the first cover 72 that is to be made of a resin material. FIG. 3 shows a portion of the first cover 42 in the circumferential direction, wherein one of the guide walls 60 is provided in the shown portion. The first mould 70 is a mould for forming mainly an outer periphery of the first cover 42 and a portion of the first cover 42 in which the resolver coils 36 are to be stored when the first cover 42 has been attached to the resolver 30. The second mould 72 is a mould for forming mainly the oil guide 50. As shown in FIG. 3, considering that each of the guide walls 60c is inclined, the withdrawing direction of the first and second moulds 70, 72 are left and right directions in the drawing sheet, which are indicated by arrows. That is, in process of production of the first cover 42, the oil guide 50 including the inclined guide walls 60c can be formed by withdrawing the first and second moulds 70, 72 in the respective directions indicated by the arrows shown in FIG. 3.

As described above, in the present embodiment, the oil guide 50 provided in the first cover 42 includes the guide wall 60c which extends in the direction of the rotation axis CL and which extends in the circumferential direction of the first cover 42, and at least a portion of the guide wall 60c overlaps with the coil end 24a as seen from the radial direction. Thus, when the oil released from the second supply hole 54 of the coolant pipe 48 is moved along the first cover 42 and then is supplied to the oil guide 50, the oil is moved along the guide wall 60c in the direction of the rotation axis CL and drops from the distal end of the guide wall 60c, so that the oil having dropped from the distal end of the guide wall 60c is supplied to the lower portion of the coil end 24a. Therefore, the oil can be appropriately supplied to the lower portion of the coil end 24a. Further, since the oil guide 50 is provided in the first cover 42 covering the resolver coil 36, the oil guide 50 can be provided on the inner peripheral side of the coil end 24a even where the electric motor MG is made compact in size.

Further, in the present embodiment, when the oil supplied from the second supply hole 54 of the coolant pipe 48 reaches the first cover 42, the oil is moved downwardly along the inner-peripheral arc wall 60a. Further, since the inner-peripheral protruding wall 60b is provided to extend in the radial direction from the end portion of the inner-peripheral arc wall 60a which is located on the lower side of the rotation axis CL, the oil moved downwardly along the inner-peripheral arc wall 60a collides with the inner-peripheral protruding wall 60b, whereby the direction of flow of the oil is changed to the radial direction in which the inner-peripheral protruding wall 60b extends. In this instance, since the guide wall 60c is connected to the outer end of the inner-peripheral protruding wall 60b, the oil moved in the radial direction is moved along the guide wall 60c in the direction of the rotation axis CL, and then drops from a distal end of the guide wall 60c toward the lower portion of the coil end 24a. Thus, the oil supplied from the coolant pipe 48 is collected onto the guide wall 60c via the inner-peripheral arc wall 60a and inner-peripheral protruding wall 60b, so that the oil is efficiently supplied to the lower portion of the coil end 24a. Further, the outer-peripheral arc wall 62a is provided on the outer peripheral side of the inner-peripheral arc wall 60a so as to cover the outer peripheral side of the inner-peripheral arc wall 60a. Therefore, even if the oil is deviated from the inner-peripheral arc wall 60a, the deviated oil is returned by the outer-peripheral arc wall 62a onto the inner-peripheral arc wall 60a, so that it is possible to reduce flow of the oil out from the inner-peripheral arc wall 60a. Further, since the outer-peripheral arc wall 62a is provided with the cutout 64 that is located on the upper side of the rotation axis CL, the oil supplied from the coolant pipe 48 is guided through the cutout 64 toward the inner peripheral side of the outer-peripheral arc wall 62a. Further, the guide wall 60c is inclined downwardly as the guide wall 60c extends in the direction of the rotation axis CL toward the electric motor MG, so that the oil having arrived the guide wall 60c is moved in the direction of the rotation axis CL owing to inclination of the guide wall 60c. Consequently, the oil having arrived the guide wall 60c is moved along the guide wall 60c so as to be efficiently supplied to the lower portion of the coil end 24a. Still further, the oil supplied from the coolant pipe 48 passes through the uppermost elongated hole 40 provided through the resolver stator 32 so as to be supplied toward the first cover 42. Therefore, even where it is difficult to supply the oil toward the first cover 42 through a clearance defined between the resolver and the coil end 24a, the oil supplied from the coolant pipe 48 can be supplied toward the first cover 42. Moreover, the oil guide 50 is formed integrally with the first cover 42, so that it is possible to avoid a new part or component from being added to form the oil guide 50.

While the preferred embodiment of this invention has been described in detail by reference to the drawings, it is to be understood that the invention may be otherwise embodied.

For example, in the above-described embodiment, an outside diameter of the resolver stator 32 of the resolver 30 is larger than an inside diameter of the coil end 24a, and the resolver stator 32 is disposed in a position that does not overlaps with the coil end 24a as seen from the radial direction. However, this arrangement is not essential for the present invention. For example, the outside diameter of the resolver stator 32 may be smaller than the inside diameter of the coil end 24a, and the resolver 30 may be disposed in a space defined between the coil end 24a and the rotor shaft 16 in the radial direction.

In the above-described embodiment, the coolant pipe 48 is disposed on the upper side of the electric motor MG, and the oil is released from the first and second supply holes 52, 54 provided in the coolant pipe 48. However, this arrangement is not essential. For example, an oil passage may be defined in a casing covering an upper portion of the electric motor MG, and the oil may be supplied from a supply hole or holes connected to the oil passage defined in the casing, toward the electric motor MG. In short, the present invention is applicable to any construction including the refrigerant supply mechanism configured to supply the oil to the electric motor MG.

In the above-described embodiment, each of the guide walls 60c is inclined downwardly in the vertical direction as it extends toward the electric motor MG in the direction of the rotation axis CL. However, each of the guide walls 60c does not necessarily have to inclined but may be parallel to the rotation axis CL.

In the above-described embodiment, the pair of oil capture walls 62b are provided to extend outwardly in the radial direction from the end portions of the respective two divided walls into which the outer-peripheral arc wall 62a is divided by the cutout 64. However, the provision of the oil capture walls 62b is not essential so that the oil capture walls 62b does not necessarily have to be provided.

In the above-described embodiment, the outer-peripheral guide portion 62 is provided on the outer peripheral side of the inner-peripheral guide portion 60. However, the outer-peripheral guide portion 62 does not necessarily have to be provided.

In the above-described embodiment, the oil is be supplied toward the first cover 42 through one of the elongated holes 40 that are provided for adjusting the position of the resolver stator 32. However, the oil may be supplied toward the first cover 42 through, in place of any one of the elongated holes 40, a through-hole that is provided through the resolver stator 32 for exclusively allowing the oil to pass therethrough so as to be supplied toward the first cover 42.

In the above-described embodiment, the oil released from the second supply hole 54 of the coolant pipe 48 is to be supplied toward the first cover 42 through one of the elongated holes 40. However, the oil does not necessarily have to be caused to pass through any one of the elongated holes 40 but may be caused to pass through, for example, a clearance defined between the resolver stator 32 and the coil end 24a in the direction of the rotation axis CL.

In the above-described embodiment, the first cover 42 and the oil guide 50 are formed integrally with each other. However, the first cover 42 and the oil guide 50 may be formed separately from each other and then may be fixed to each other.

It is to be understood that the embodiment described above is given for illustrative purpose only, and that the present invention may be embodied with various modifications and improvements which may occur to those skilled in the art.

### NOMENCLATURE OF ELEMENTS

12: stator
14: rotor
16: rotor shaft (shaft)
18: stator core
20: stator coil
22: motor casing (non-rotary member)
24a: coil end
30: resolver
32: resolver stator
34: resolver rotor
40: elongated hole (through-hole)
42: first cover (annular-shaped cover)
46: cooling device
48: coolant pipe (refrigerant supply mechanism)
50: oil guide
52: first supply hole (supply hole)
54: second supply hole (supply hole)
60a: inner-peripheral arc wall (arc wall)
60b: inner-peripheral protruding wall (protruding wall)
60c: guide wall
62a: outer-peripheral arc wall (second arc wall)
64: cutout
MG: electric motor

What is claimed is:

1. A cooling device for an electric motor that includes (i) a tubular stator including a tubular stator core and a stator coil passing through the stator core in a direction of a rotation axis of the electric motor, (ii) a tubular rotor disposed on an inner peripheral side of the stator and (iii) a shaft fixed in an inner circumferential surface of the rotor, such that the electric motor is located in a position adjacent to a resolver in the direction of the rotation axis, and such that the resolver includes a resolver stator fixed to a non-rotary member, a resolver rotor and a resolver coil that is wound on the resolver stator;
the cooling device comprising:
a refrigerant supply mechanism configured to supply a refrigerant to the electric motor; and
an oil guide which is provided in an annular-shaped cover covering the resolver coil, and which is configured to supply the refrigerant supplied from the refrigerant supply mechanism onto a portion of a coil end that is provided by a protruding portion of the stator coil protruding from the stator core, the portion of the coil end being located on a lower side of the rotation axis in a vertical direction,
wherein the oil guide includes a guide wall which extends in the direction of the rotation axis, and which extends in a circumferential direction of the annular-shaped cover, and
wherein at least a portion of the guide wall overlaps with the coil end as seen from a radial direction orthogonal to the rotation axis.

2. The cooling device according to claim 1,
wherein the oil guide further includes an arc wall having an arc shape and extending in the circumferential direction of the annular-shaped cover, and a protruding wall extending in the radial direction from an end portion of the arc wall which is located on the lower side of the rotation axis in the vertical direction, and
wherein the guide wall is connected to an outer end of the protruding wall in the radial direction.

3. The cooling device according to claim 2,
wherein the oil guide includes, in addition to the arc wall as a first arc wall, a second arc wall that is located on an outer peripheral side of the first arc wall so as to cover the outer peripheral side of the first arc wall, and
wherein the second arc wall is provided with a cutout that is located on an upper side of the rotation axis in the vertical direction so as to guide an oil supplied from the refrigerant supply mechanism toward an inner peripheral side of the second arc wall.

4. The cooling device according to claim 1,
wherein the guide wall is inclined downwardly in the vertical direction, as the guide wall extends in the direction of the rotation axis toward the electric motor.

5. The cooling device according to claim 1,
wherein the refrigerant supply mechanism is configured to supply the refrigerant released from the refrigerant supply mechanism, to the oil guide through a through-hole that extends through the resolver stator in the direction of the rotation axis.

6. The cooling device according to claim 1,
wherein the oil guide is made of a resin material, and
wherein the oil guide is formed integrally with the annular-shaped cover.

7. The cooling device according to claim 1,
wherein the refrigerant supply mechanism is a coolant pipe which is disposed on an upper side of the electric motor in the vertical direction and which is provided with a supply hole through which the refrigerant is to be released.
